(19) United States
(12) Patent Application Publication
(10) Pub. No.: US 2002/0096582 A1
(43) Pub. Date: Jul. 25, 2002

(54) Shaping air distribution methods and apparatus

(76) Inventor: John H. Edelhauser, Troy, MI (US)

Correspondence Address: BARNES & THORNBURG, 11 SOUTH MERIDIAN, INDIANAPOLIS, IN, 46204

(21) Appl. No.: 09/766,106

(22) Filed: Jan. 19, 2001

(51) Int. Cl. B05B 5/03; B05B 5/00

(52) U.S. Cl. 239/700; 239/705; 239/706; 239/708

(57) ABSTRACT

A coating dispensing apparatus includes an atomizer and a housing for the atomizer. The housing includes a forward end defining an opening through which coating material dispensed by the atomizer is discharged. The forward end includes an inner portion and an outer portion. One of the inner portion and the outer portion includes a first surface. The other of the inner and outer portions includes a second surface. At least one of the first and second surfaces includes grooves which extend to the forward end and terminate around the opening. Compressed gas supplied to the grooves remote from the opening flows toward the forward end and exits from the grooves around the opening.

### FIELD OF THE INVENTION

This invention relates to the atomization and dispensing of coating materials. It is disclosed in the context of a dispensing system and method for coating materials, such as electrically conductive liquid coating materials, electrically nonconductive liquid coating materials, and fluent pulverulent coating materials, but has utility in other applications as well.

### BACKGROUND OF THE INVENTION

Various apparatus and methods for distributing so-called shaping air around an atomizer are known. Such shaping air is dispensed primarily to shape and provide an envelope for the cloud of atomized coating material that forms in front of the atomizer in the space between the atomizer and the article, or target, to be coated by the atomized coating material dispensed from the atomizer. There are, for example, the systems illustrated and described in U.S. Pat. Nos. 5,632,448 and 5,853,126, the disclosures of which are hereby incorporated herein by reference. No representation is intended that a complete search of all pertinent art has been conducted or that there is no better art than that listed. Nor should any such representation be inferred.

The housings, or shrouds, which somewhat surround and enclose the atomizers of such systems generally include galleries which extend from points remote from the openings in the shrouds through which atomized coating material is dispensed to the regions of the shrouds around the openings. Pressurized gases or mixtures of gases, such as, for example, compressed air, are supplied to these galleries, and are exhausted from these galleries in the regions surrounding such openings to provide a shaping air envelope which to some degree contains and shapes the cloud of atomized coating material which is being dispensed from the atomizer.

Such shrouds typically are constructed from relatively less rigid filled and unfilled resins. The shrouds are removed and replaced from time to time during the course of operation of coating application facilities in which they are utilized for routine maintenance and the like. A desirable maintenance cycle might be, for example, four hours of uninterrupted operation, followed by whatever maintenance is required, then another four hours of uninterrupted operation, and so on. The handling of such a shroud almost inevitably results in the shroud being subject to some deformation. Additionally, the shrouds and other components of such systems are subject to manufacturing tolerance variations. All of these factors contribute to non-uniformity of the pattern such as, for example, by causing asymmetry of the shaping air envelope around the opening in the remote end of the shroud which surrounds the nozzle or bell cup from which the coating material is dispensed. Non-uniformity of the shaping air distribution affects, generally by causing non-uniformity of, the pattern of shaping air itself, and resulting non-uniformity of the pattern of coating material in the coating material cloud dispensed from the atomizer.

Additionally, proposals have been advanced to monitor the flow of shaping air, with the objective of determining when variation in the flow rate of shaping air varies from some established nominal value by some predetermined amount. The thought is that if and as such variations occur, they signal less than optimal performance of the coating material atomizing and dispensing systems, and indicate the need for curative maintenance. If any of such proposals are ultimately implemented, there must be some nominal level of performance of a dispensing system, for example, an agreed-upon uniform shaping air envelope, against which any monitored flow can be measured.

### DISCLOSURE OF THE INVENTION

According to the invention, a coating dispensing apparatus includes an atomizer and a housing for the atomizer. The housing includes a forward end defining an opening through which coating material dispensed by the atomizer is discharged. The forward end includes an inner portion and an outer portion. One of the inner portion and the outer portion includes a first surface. The other of the inner and outer portions includes a second surface. At least one of the first and second surfaces includes grooves which extend to the forward end and terminate around the opening. Compressed gas supplied to the grooves remote from the opening flows toward the forward end and exits from the grooves around the opening.

Illustratively according to the invention, the coating dispensing apparatus includes a plenum chamber remote from the opening. The grooves intersect the plenum chamber remote from the opening.

Further illustratively according to the invention, except for the grooves provided in the at least one of the first and second surfaces, the first and second surfaces are complementarily shaped.

Illustratively according to the invention, the complementarily shaped first and second surfaces include complementarily shaped frusta of a solid, for example, a cone.

Additionally illustratively according to the invention, the inner and outer portions include complementarily threaded portions. The threaded portion of the inner portion is threaded, remotely from the opening, into the threaded portion of the outer portion.

Further illustratively according to the invention, the threaded portion of the outer portion includes an internally threaded region and the threaded portion of the inner portion includes an externally threaded region. The threads of the externally threaded region engage the threads of the internally threaded region to orient the first and second surfaces adjacent one another.

### BRIEF DESCRIPTION OF THE DRAWINGS

The invention may best be understood by referring to the following detailed description and accompanying drawings which illustrate the invention. In the drawings:

FIG. 1 illustrates a partly exploded side elevational view of a system constructed according to the invention;

FIG. 2 illustrates a front elevational view of a component of a system constructed according to the present invention;

FIG. 3 illustrates a sectional side elevational view of the component illustrated in FIG. 2, taken generally along section lines 3-3 of FIG. 2;

FIG. 4 illustrates a rear elevational view of a component of a system constructed according to the present invention;

FIG. 5 illustrates a sectional side elevational view of the component illustrated in FIG. 4, taken generally along section lines 5-5 of FIG. 4;

FIG. 6 illustrates a rear elevational view of the assembled components illustrated in FIGS. 2-5;

FIG. 7 illustrates a sectional side elevational view of the assembled components illustrated in FIG. 6, taken generally along section lines 7-7 of FIG. 6;

FIG. 8 illustrates a rear elevational view of a component of a system constructed according to the present invention;

FIG. 9 illustrates a sectional side elevational view of the component illustrated in FIG. 8, taken generally along section lines 9-9 of FIG. 8;

FIG. 10 illustrates a side elevational view of a component of a system constructed according to the present invention;

FIG. 11 illustrates a front elevational view of the component illustrated in FIG. 10;

FIG. 12 illustrates an enlarged fragmentary front elevational view of a detail of the component illustrated in FIGS. 10-11;

FIG. 13 illustrates a rear elevational view of the component illustrated in FIGS. 10-11; and,

FIG. 14 illustrates a sectional side elevational view of the component illustrated in FIGS. 10-13, taken generally along section lines 14-14 of FIG. 11.

### DETAILED DESCRIPTIONS OF ILLUSTRATIVE EMBODIMENTS

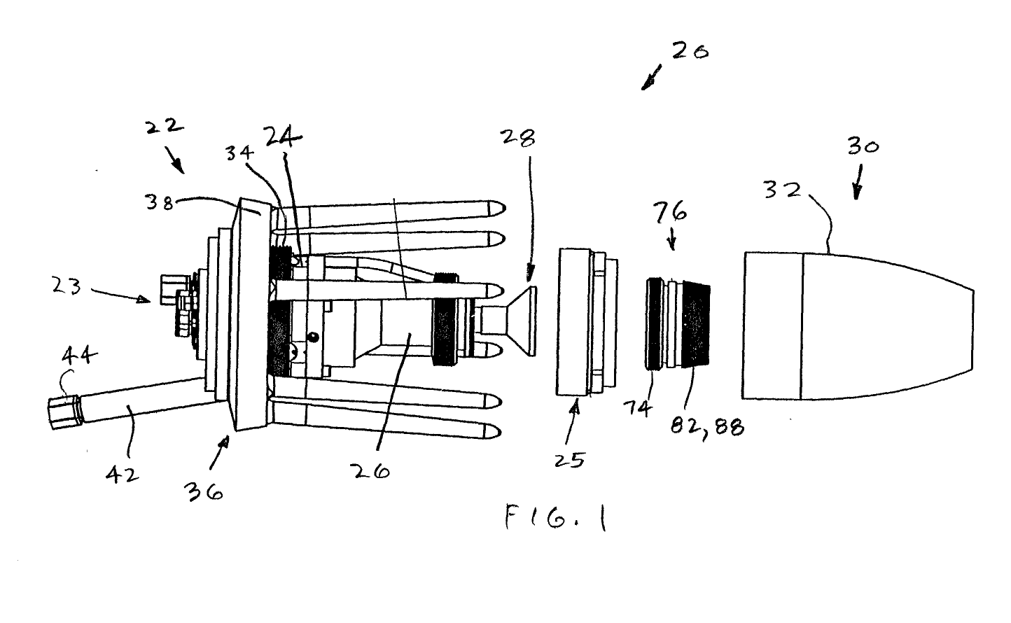

Referring now particularly to FIG. 1, an atomizer 20 includes a manifold assembly 22 for providing the various services 23, such as high and low pressure compressed air, high and low pressure solvent, coating material, and the like to the atomizer 20. The identity of the solvent depends upon the type of coating material being dispensed. A typical solvent might be, for example, water or a volatile organic compound. The various services 23 are provided to a valve module assembly 24 by which flows of the various services to the atomizer 20 are controlled. A module retaining ring 25 retains the module assembly 24 on the manifold assembly 22. A typical, although by no means the only, atomizer 20 includes a gas-powered turbine 26 which spins a bell cup 28. Illustratively, turbine 26 is powered by compressed air. Bell cup 28 may be of the general type described in, for example, one of the following U.S. Patents, the disclosures of which are hereby incorporated herein by reference: U.S. Pat. Nos. 5,433,387; 5,622,563; 5,633,306; 5,662,278; 5,957,395; 6,042,030; and, 6,076,751. Again, no representation is intended that a complete search of all pertinent art has been conducted or that there is no better art than that listed. Nor should any such representation be inferred.

The turbine 26 and bell cup 28 are housed within a shroud 30 including an outer portion 32 which is attached, for example, by engagement of threads 34 on the shroud 30 and manifold 22, to form the assembly 20. The illustrated assembly 20 dispenses conductive coating material which is then charged by a charging mechanism 36 including a high voltage charging ring 38, electrodes 40 which extend axially forward and radially outward at acute angles to a rotational axis of turbine 26 from the high voltage charging ring 38, a high voltage coupling tube 42 and a high voltage coupling compression nut 44 by which assembly 20 is coupled to a high-magnitude potential supply of the general type disclosed in, for example, one of the following U.S. Patents, the disclosures of which are hereby incorporated herein by reference: U.S. Pat. Nos. 5,632,816; 5,978,244; 6,144,570; and the references cited in all of these. Again, no representation is intended that a complete search of all pertinent art has been conducted or that there is no better art than that listed. Nor should any such representation be inferred. It should be understood that the invention may also be used with a system in which the coating material is directly charged, for example, by contact with (an) electrically charged surface(s), for example, on the bell cup 28 which is (are) maintained at high-magnitude electrostatic potential.

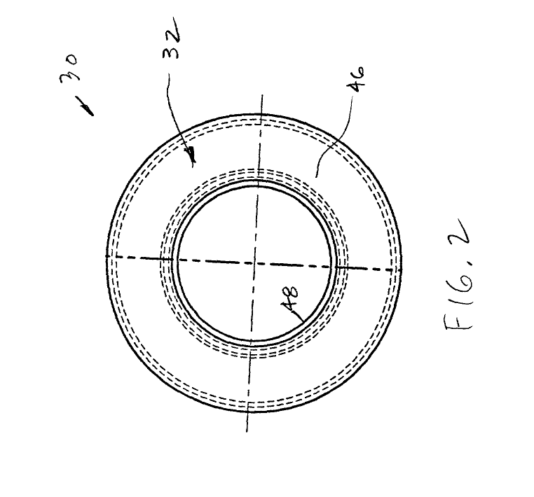

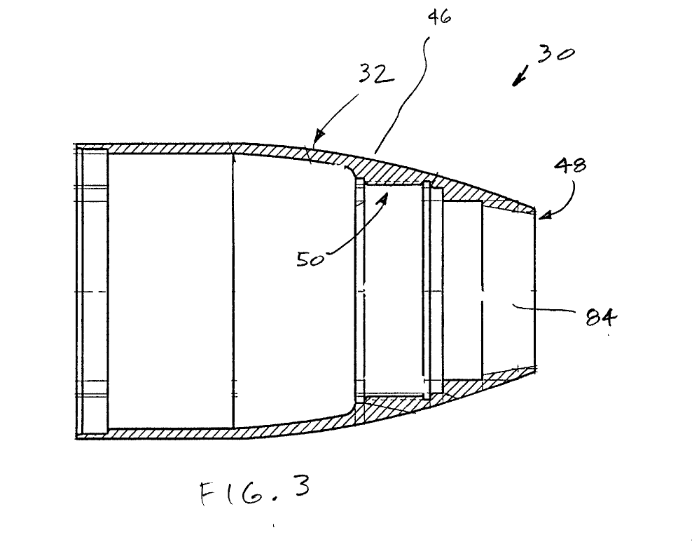

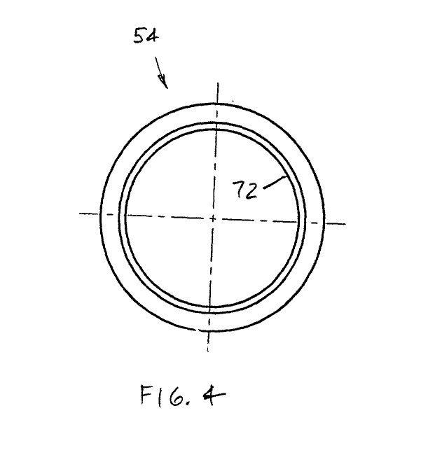

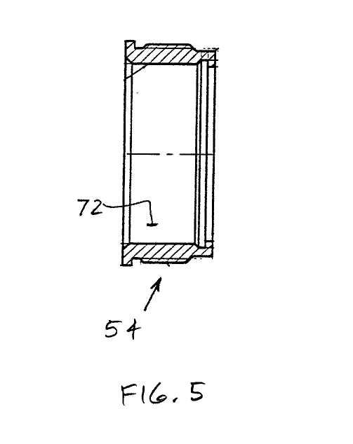

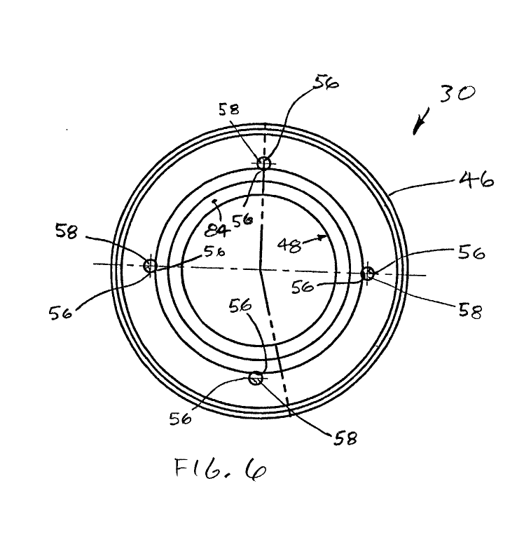

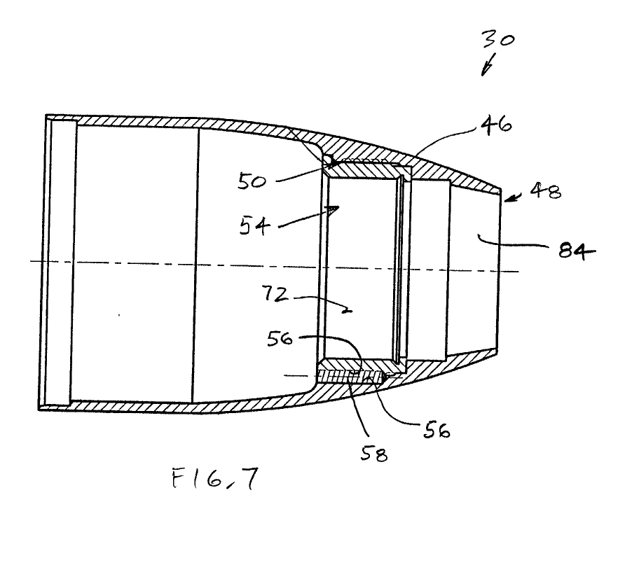

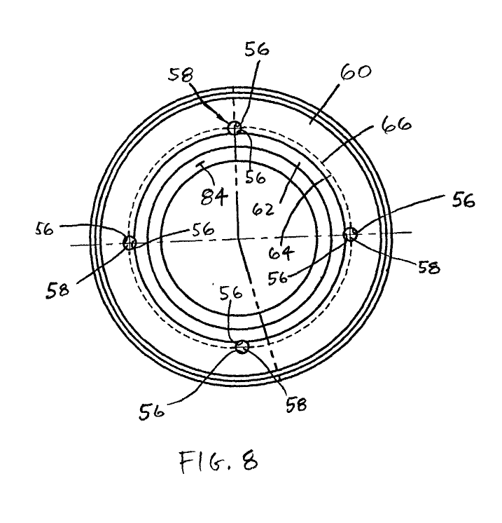

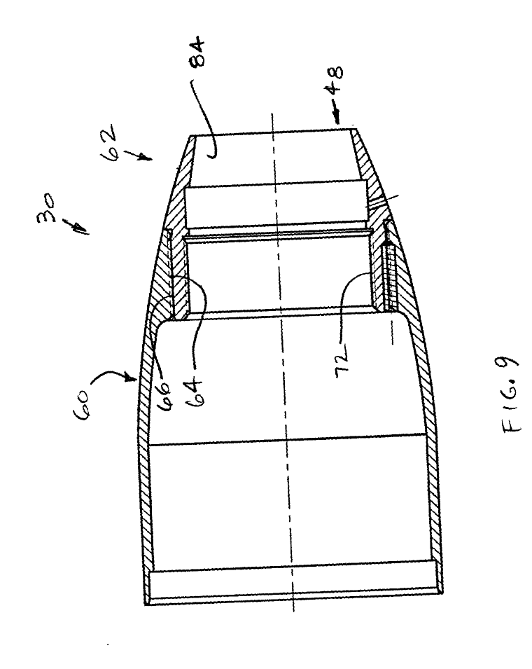

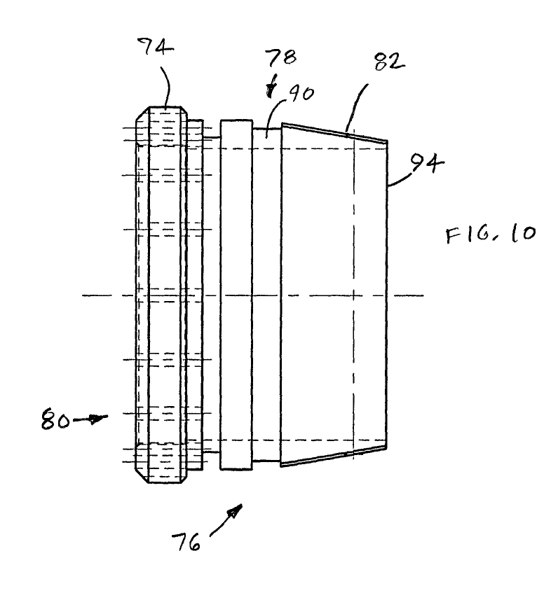

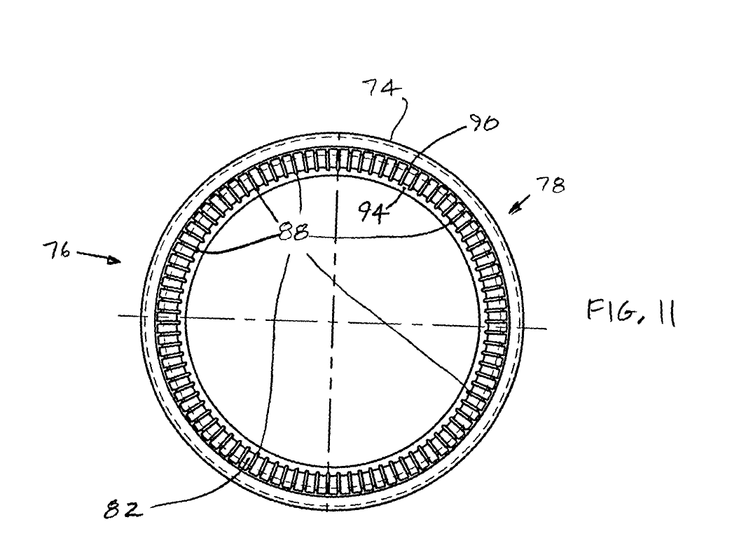

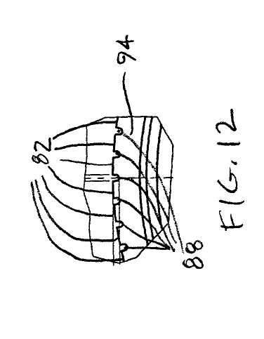

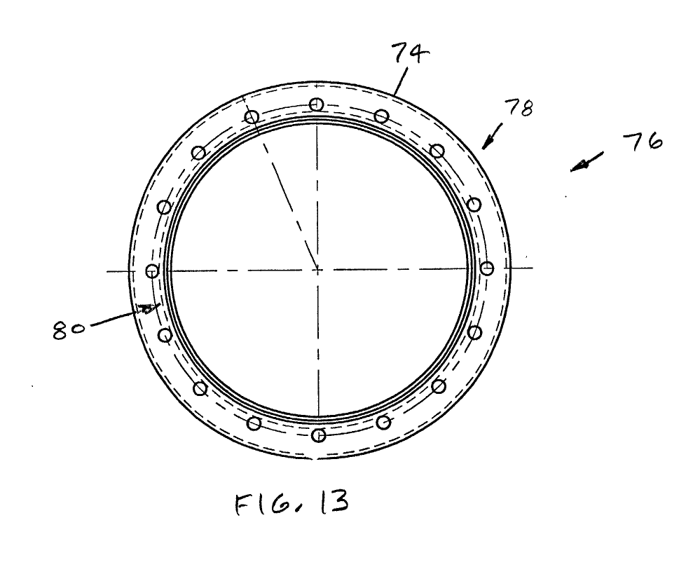

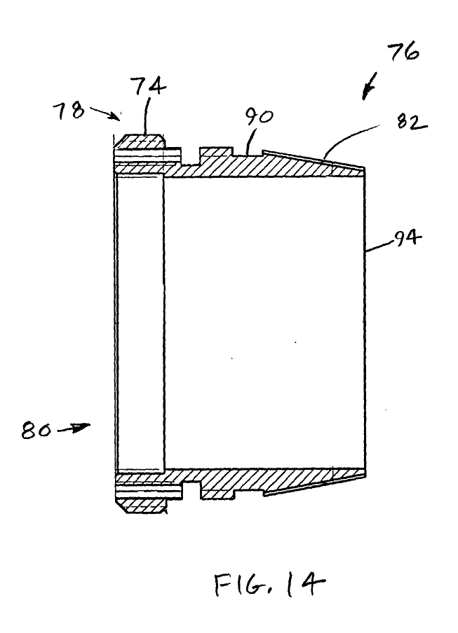

Referring now particularly to FIGS. 2-3, the shroud 30 includes an outer, somewhat projectile shaped portion 46, the forward end 48 of which is open to permit the discharge of atomized coating material from the forward end of bell cup 28 therethrough. Illustratively, the shroud 30 is provided with an internally screw-threaded portion 50 into which is threaded an externally screw-threaded portion 54. See FIGS. 4-5. The two portions 50, 54 are pinned together at a position at which axially extending reliefs 56 in both mate by pressing pins 58 having appropriate cross-sectional configurations into the mating reliefs 56 of the two portions 50, 54. See FIGS. 6-7. In another configuration of the shroud 30 illustrated in FIGS. 8-9, the outer shroud 30 itself includes a rearward portion 60 and a forward portion, or shaping air cap, 62. The rearward portion 60 is provided with an open forward end having internal threads 64. The forward portion 62 is provided with an open rearward end having external threads 66. The forward portion 62 is threaded into the rearward portion 60. The two portions 60, 62 are pinned together at a position at which axially extending reliefs 56 in both mate by pressing pins 58 having appropriate cross-sectional configurations into the mating reliefs 56 of the two portions 60, 62. In either event, portion 54, 62 itself is internally threaded 72 to engage external threads 74 on a shaping air ring 76. See FIGS. 10-14.

The external threads 74 on shaping air ring 76 are provided on the outer surface 78 thereof adjacent its rearward end 80. Forwardly from external threads 74, shaping air ring 76 is provided with a somewhat frustoconical outer surface 82 the configuration of which is complementary to the configuration of an inner surface 84 of shroud outer portion 46 or forward portion 62. Surface 82 is provided with a number, illustratively ninety, of axially forwardly and radially inwardly extending, uniformly angularly spaced grooves 88 which extend from a circumferentially extending groove which cooperates with shroud 30 to form an air distribution plenum 90. Air plenum 90 is provided with air in somewhat the same manner as described in, for example, U.S. Pat. No. 5,632,448. The air is distributed uniformly around the front opening 48 in shroud 30 through the grooves 88 which open into an end face 94 of shaping air ring 76.

What is claimed is:

1. A coating dispensing apparatus including an atomizer, a housing for the atomizer, the housing including a forward end defining an opening through which coating material dispensed by the atomizer is discharged, the forward end including an inner portion and an outer portion, one of the inner portion and the outer portion including a first surface, the other of the inner and outer portions including a second surface, at least one of the first and second surfaces including grooves which extend to the forward end and terminate around the opening, compressed gas supplied to the grooves remote from the opening flowing toward the forward end and exiting from the grooves around the opening.

2. The coating dispensing apparatus of claim 1 further including a plenum chamber remote from the opening, the grooves intersecting the plenum chamber remote from the opening.

3. The coating dispensing apparatus of claim 2 wherein except for the grooves provided in the at least one of the first and second surfaces, the first and second surfaces are complementarily shaped.

4. The coating dispensing apparatus of claim 3 wherein the complementarily shaped first and second surfaces include complementarily shaped frusta of a solid.

5. The coating dispensing apparatus of claim 4 wherein the inner and outer portions include complementary threaded portions, the threaded portion of the inner portion being threaded, remotely from the opening, into the threaded portion of the outer portion.

6. The coating dispensing apparatus of claim 5 wherein the threaded portion of the outer portion includes an internally threaded region and the threaded portion of the inner portion includes an externally threaded region, the threads of the externally threaded region engaging the threads of the internally threaded region to orient the first and second surfaces adjacent one another.

7. The coating dispensing apparatus of claim 1 wherein except for the grooves provided in the at least one of the first and second surfaces, the first and second surfaces are complementarily shaped.

8. The coating dispensing apparatus of claim 7 wherein the complementarily shaped first and second surfaces include complementarily shaped frusta of a solid.

9. The coating dispensing apparatus of claim 8 wherein the inner and outer portions include complementary threaded portions, the threaded portion of the inner portion being threaded into the threaded portion of the outer portion from remote from the opening.

10. The coating dispensing apparatus of claim9 wherein the threaded portion of the outer portion includes an internally threaded region and the threaded portion of the inner portion includes an externally threaded region, the threads of the externally threaded region engaging the threads of the internally threaded region to orient the first and second surfaces adjacent one another.

11. The coating dispensing apparatus of claim 1 wherein the inner and outer portions include complementary threaded portions, the threaded portion of the inner portion being threaded into the threaded portion of the outer portion from remote from the opening.

12. The coating dispensing apparatus of claim 11 wherein the threaded portion of the outer portion includes an internally threaded region and the threaded portion of the inner portion includes an externally threaded region, the threads of the externally threaded region engaging the threads of the internally threaded region to orient the first and second surfaces adjacent one another.
